(19) United States
(12) Patent Application Publication
(10) Pub. No.: US 2010/0145975 A1
(43) Pub. Date: Jun. 10, 2010

(54) Expansion of Search Queries Using Information Categorization

(76) Inventors: Michael Ratiner, Holon (IL); Dmitry Kuharenko, Staten Island, NY (US); Dan Eliav, Yaakov (IL); Alexander Rubinov, Holon (IL); Avishay Maloul, Netanya (IL)

Correspondence Address: The Law Office of Michael E. Kondoudis, 888 16th Street, N.W., Suite 800, Washington, DC, 20006, US

(21) Appl. No.: 12/328,602

(22) Filed: Dec. 4, 2008

(51) Int. Cl. G06F 17/30; G06Q 30/00; G06F 7/00

(52) U.S. Cl. 707/765; 707/E17.014; 707/E17.017; 707/E17.136; 705/14.54

(57) ABSTRACT

A computerized system and method of constructing and expanding search queries for conducting searches through information sources. The system enables retrieving a category options tree, allowing a user to define a category route by selecting a category-node, which defines a search-category. The system may further enable retrieving a query scenario tree, having a hierarchal structure comprising query nodes, where the retrieved query scenario tree is associated with an initial input query, inputted by a user. Each query node defines a query route enabling to construct the content and structure of an expanded search query. The system enables selecting a query node of the retrieved query scenario tree, according to an online decision making process, which analyses the search-category in relation to available query routes in to allow selecting a query node from the retrieved scenario tree that is most compatible with the search-category.

### BACKGROUND

1. Field of the Invention

The present invention relates generally to the field of systems, methods and search engines for information retrieval based on hierarchic data knowledge and more particularly to systems, methods and search engines enabling dynamic searches by enabling dynamic expansion of input search queries.

2. Discussion of Related Art

Search engines are targeted at retrieving information from databases, organized according to different hierarchies, pertaining to an input query inserted by a user. The input query is usually textual (a word or a combination of words), where the search engine usually “reads” the text query according to predefined rules enabling the engine to search through the data sources according to keywords in the text and according to the structure of the input query.

Search engines are often scaled according to the relevancy of information they enable to retrieve in relation to the input query complexity and/or according to the way they facilitate the user in building a query that will lead to a more relevant search results. Many websites charge advertisers for presenting their ads according to search queries and since the advertiser usually pays for each presentation. Therefore, it is highly important for advertisers to reach audiences that are more likely to be potential customers and avoid redundant charging.

To allow a more focused and relevant search through the enormous amount of data sources and data that is available, some search interfaces allow the user to input personal details such as gender, age, nationality, and the like and create a personal profile of the user to further facilitate in searching for information that relates to the personal details of the user in addition to his/her input query text. For example, the search results for a query input text “old movies” inputted by an American male at the age of fifty may be different from the results of a sixteen-year-old Swedish girl.

To further improve searching the data sources, many systems use hierarchic interfaces enabling users to build more structured and elaborated queries.

Unfortunately, those techniques require the user to input personal details, which the user may be reluctant to reveal.

Another downside to these techniques is that the personal input details that are received from the user may not be sufficient to all types of query options and may not be related to categories that can further facilitate in associating the right search results to the query of the user in relation to the user's input details.

### SUMMARY

The present invention, according to some embodiments thereof, provides a system, a method and a search engine for constructing and expanding search queries and conducting searches through at least one information source.

According to some embodiments of the invention, the system and search engine may enable retrieving a category options tree, which is a hierarchal logic tree, which may or may not be graphically presented. The at least one category options tree may allow a user to define a category route, which defines a search-category.

The system may further enable a user to input an initial input query, which may comprise an initial textual input for the search. Upon receiving the input query, the system may enable retrieving a query scenario tree, having a hierarchal structure comprising query nodes, where the retrieved query scenario tree may be associated with the initial input query.

According to embodiments, each query node may comprise text that is associated with the initial input query, and where each query node may define a query route, defining the content of each node of the route and the relations between the nodes of the route, enabling to construct the content and structure of an expanded search query.

According to embodiments, the system may further enable selecting a query node of the retrieved query scenario tree, where the selection of the query node is carried out according to an online decision making process, which analyses the search-category in relation to the available query nodes and query routes in order to select a query node from the retrieved query scenario tree that is most compatible with the search-category. The system may then construct the expanded search query according to the query route defined by the selected query node.

According to embodiments, each new search requires the user to define a new search-category.

The selection of the query route and the determining of the search-category may be carried out according to predefined rules that may take into account statistical calculations of searching behavior of users, where each search-category, defined by a category route, indicates characteristics of the user in relation to the initial input query.

According to some embodiments of the invention, the computerized system may comprise a search engine; at least one categories database; and at least one query scenario trees database. The search engine may enable users, using computerized communication devices, to use the search engine to search for information by communicating with the search engine through at least one data communication network.

The search engine may further enable the user to define a search-category to each new search, by presenting the user with a retrieved category options tree, retrieved from the categories database, which is a hierarchal tree comprising category nodes, where the category options tree allows the user to define a category route by selecting a category node defining the details of the user's search-category.

The search engine may further enable retrieving a query scenario tree from the at least one query scenario trees database that is associated with an initial input query, inputted by the user, where the input query comprises an initial textual input for the search. Each query scenario tree may comprise query nodes each comprising text associated with the input query, where the search engine may further enable constructing an expanded search query, which expands the input query, by selecting a query node out of the retrieved query scenario tree that is associated with the input query, according to an online decision making process, which analyses the search-category in relation to the query nodes and query routes in order to select a query node from the retrieved query scenario tree that is most compatible with the search-category; wherein the content and structure of the expanded search query is defined by the query route, which is defined by the selected query node.

The retrieval of each category options tree may be carried out by the search engine, according to predefined rules that take into account statistical calculations of searching behavior of users, wherein at least one of the search-categories, defined by at least one of the possible category routes, indicates characteristics of the user in relation to the initial input query.

According to some embodiments, the search engine may comprise (i) a graphical user interface (GUI) enabling the users to view and input data; (ii) a search-categorization module, enabling to define a search-category by retrieving of at least one category options tree, which is a hierarchal tree comprising category nodes, which define category routes, wherein each route defines a search-category and by allowing the user to select a category node from the retrieved options tree and thereby define a category route, which defines the search-category; a query scenarios retrieval module, enabling to retrieve at least one query scenario tree, which is a hierarchal tree comprising query nodes, each node defines a query route, wherein each query route defines an expanded search query, wherein the retrieval of the query scenario tree is carried out according to an initial input query, inputted by the user; (iii) a query expansion module, enabling to expand the initial input query, by selection of a query node out of the retrieved query scenario tree, wherein the selection is carried out according to an online decision making process, which analyses the search-category in relation to the available query nodes and query routes in order to select a query node from the retrieved query scenario tree that is most compatible with the search-category; and (iv) a search module, enabling to conduct searches through the at least one information source, according to the content and structure of the constructed search query.

At least one of the search-categories, defined by at least one of the possible category routes, may indicate characteristics of the user in relation to the initial input query.

These, additional, and/or other aspects and/or advantages of the present invention are: set forth in the detailed description which follows; possibly inferable from the detailed description; and/or learnable by practice of the present invention.

### BRIEF DESCRIPTIONS OF THE DRAWINGS

The subject matter regarded as the invention will become more clearly understood in light of the ensuing description of embodiments herein, given by way of non-limiting example and for purposes of illustrative discussion of the present invention only, with reference to the accompanying drawings, wherein

FIG. 1 is a block diagram, schematically illustrating a system comprising a search engine for constructing search queries and conducting searches, according to some embodiments of the invention;

FIG. 2 schematically illustrates a category options tree for enabling a user to define a search-category, according to some embodiments of the invention;

FIG. 3 schematically illustrates a query scenario tree and the process according to which a query node is selected, according to some embodiments of the invention; and

FIG. 4 is a flowchart, schematically illustrating a method for expanding a search query, according to some embodiments of the invention.

The drawings together with the description make apparent how the invention may be embodied in practice.

### DETAILED DESCRIPTION

While the description below contains many specifications, these should not be construed as limitations on the scope of the invention, but rather as exemplifications of the preferred embodiments.

The scope of the invention should be determined not by the embodiments illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention, in some embodiments thereof, provides a computerized system 100, method and a search engine 200 for expending search queries for searching efficiently through various information sources available through at least one data communication network 99.

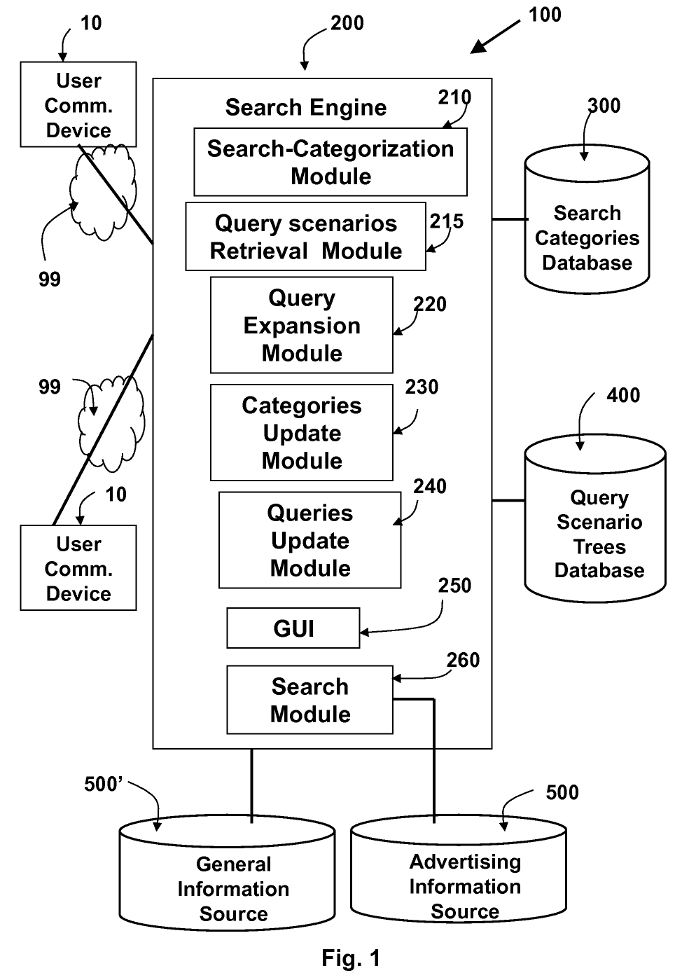

FIG. 1 is a block diagram, schematically illustrating a computerized system 100 for constructing and expending of search queries and conducting searched through various information sources using the constructed search queries, according to some embodiments of the invention.

As illustrated in FIG. 1, the system 100 may comprise a search engine 200, at least one search categories database 300 and at least one query scenario trees database 400.

According to embodiments, the search engine 200 may enable retrieving data from the databases 300 and 400.

The search engine 200 may enable users, using computerized communication devices 10, to use the search engine 200 to search through at least one information source 500/500′ for information by communicating with the search engine 200 through the at least one data communication network 99, as known in the art.

The users' communication devices 10 may be of any variety and kind known in the art that enable retrieval, transmission and presentation of data, such as CPs, laptops, PDAs, cellular phones with access to the wireless application protocol (WAP) or any other network.

The communication networks 99 that can be used are all available networks 99 known in the art that allow transmission of data therethrough in known protocols such as the internet, the WAP, the intranet etc.

According to embodiments, the search engine 200 may further enable the user to construct and expand a search query by defining a search-category to be associated with the search.

According to embodiments, the search-category may be defined by retrieving at least one category options tree, which is a hierarchal logic tree, from the at least one search categories database 300.

The at least one category options tree may allow the user to define a category route (a logic route of the tree) defining the search-category of the particular search session, by selecting a category-node of the category options tree.

According to some embodiments of the invention, the system 100 may further enable retrieving at least one query scenario tree, from the query scenario trees database 400, which is another logic tree representing possible query structures and content, once the user inputs an initial input query, which may comprise an initial textual input for the search.

The query scenario trees in the database 400 may be constructed and/or updated according to various methods, e.g. based on statistical calculations that allow constructing the logical query routes.

According to embodiments, as illustrated in FIG. 1, the search engine may comprise at least some of: a search-categorization module 210; a query scenario trees retrieval module 215; a query expansion module 220; a graphical user interface (GUI) 250; a search module 260; a categories update module 230; and a queries update module 240.

According to embodiments, the search-categorization module 210, may enable defining a search-category 30 for each search, by retrieving a categories option tree 310 from the at least one search categories database 300, by allowing the user to select a category node 311, which defines a category route 320 which defines the search-category 30.

According to embodiments, the query scenario trees retrieval module 215 may enable retrieving of at least one query scenario tree 410 from the at least one search query scenario trees database 400, once a textual initial input query is inputted by a user. The search for the query scenario tree 410 that is associated with the text of the input query may be carried out according to any method and algorithm that allows logical associating of text to predefined query scenario trees 410.

According to embodiments, the query expansion module 220, may enable expanding the inputted initial input query by constructing of an expanded search query 50, according to the input query and according to the defined search-category 30. The expansion may be carried out by selecting a query node (carried out automatically be the system) of the retrieved query scenario tree. The selection of the query node may be carried out according to an online decision making process predefined at the expansion module 220, which analyses the search-category in relation to the available query nodes and query routes in order to select a query node from the retrieved query scenario tree that is most compatible with the search-category.

According to embodiments, the graphical user interface (GUI) 250 may be operatively associated with all other modules of the search engine 200, enabling the user to input the initial input query 20, presenting the category options trees 310 and allowing the user to select category nodes 311, presenting the expanded search query and the search results according to predefined graphical configuration and rules (e.g. predefined priorities), etc.

According to embodiments, the search module 260 may allow conducting the searches through the at least one information source 500′ and/or 500, according to the content and structure of the expanded search query 50.

According to embodiments, the update module 230 may enable updating the structure and content of the category options trees 310 according to new knowledge acquired by the system 100 (e.g. more statistical analysis and/or new studies and methods in analyzing the behavioral information relating to users' searching behavior). The updating may include adding new category options trees 310 and/or updating existing ones (e.g. by adding/removing nodes 311).

According to embodiments, the queries update module 240 may enable updating the structure and content of the query scenario trees 410 according to new knowledge acquired by the system 100 (e.g. more statistical analysis and/or new studies and methods in analyzing the behavioral information relating to users' searching behavior in relation to query construction). The updating may include adding new query scenario trees 410 and/or updating existing ones (e.g. by adding/removing/replacing nodes 411 and/or by redefining the relations between each two connected nodes 411).

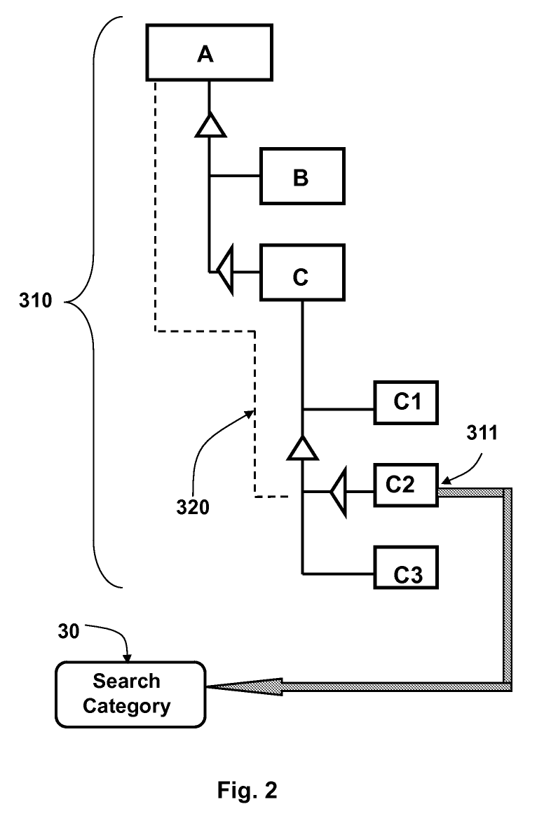

FIG. 2 schematically illustrates the structure and logics of a category options tree 310, according to some embodiments of the invention. The category options tree 310 may be a graphical logic tree graphically presenting category nodes 311 which may be graphical predefined images/pictures or media such as animation or video. As illustrated in FIG. 2, each category options tree 310 may comprise category nodes 311 each category node 311 representing a route 320 defining all the nodes 311 that relate to the selected one and the relations between the route's 320 nodes 311. Each route 320 may be associated with a different search-category 30, according to predefined rules that may take into account, for instance, statistical calculations and/or studies of searching behavior of users, where each search-category, defined by a category route, indicates, inter alia, characteristics of the user, without requiring the user to identify personal details such as his age, name, sex and the like.

The statistical calculations and/studies of users searching behaviors may include social studies of already known user's profiles and their search histories and/or according to the users searching usage and/or feedback, when using the system 100.

At least one of the search-categories 30, defined by at least one of the possible category routes 320, may indicate characteristics of the user. This means that the search-category 30 may represent a profile of the search session and/or a profile that characterizes the user in relation to the search the user is about seek. Each new search requires the user to define a new search-category 30 enabling later on to check, for example, the historical relations between the selected category and the input query for further updating the query scenario trees with more relevant relations between the content of the query nodes and the search-category 30.

For example, it may be discovered that all searches that related to search-categories 30 that included “a male user, under the age of twenty who likes ski and sports” are related in considerable statistical rate to input queries that relate to “cellular phones” and their expanded queries relate especially to “online games in cellular phones”.

According to embodiments, the categories options tree 310 may be a graphical hierarchal options tree 310 enabling the user to graphically define the search-category by selecting a graphically presented category node 311 that defines a route 320, which is associated with a specific predefined search-category 30.

According to some embodiments, as illustrated in FIG. 1, at least one of the information sources may be an advertising information source 500, enabling to retrieve advertising information that is associated with the search-category 30 according to the content and structure of its associated search query 50.

According to embodiments, the system 100 may enable automatically retrieving of a query scenario tree 410 that is associated with the initial input query 20.

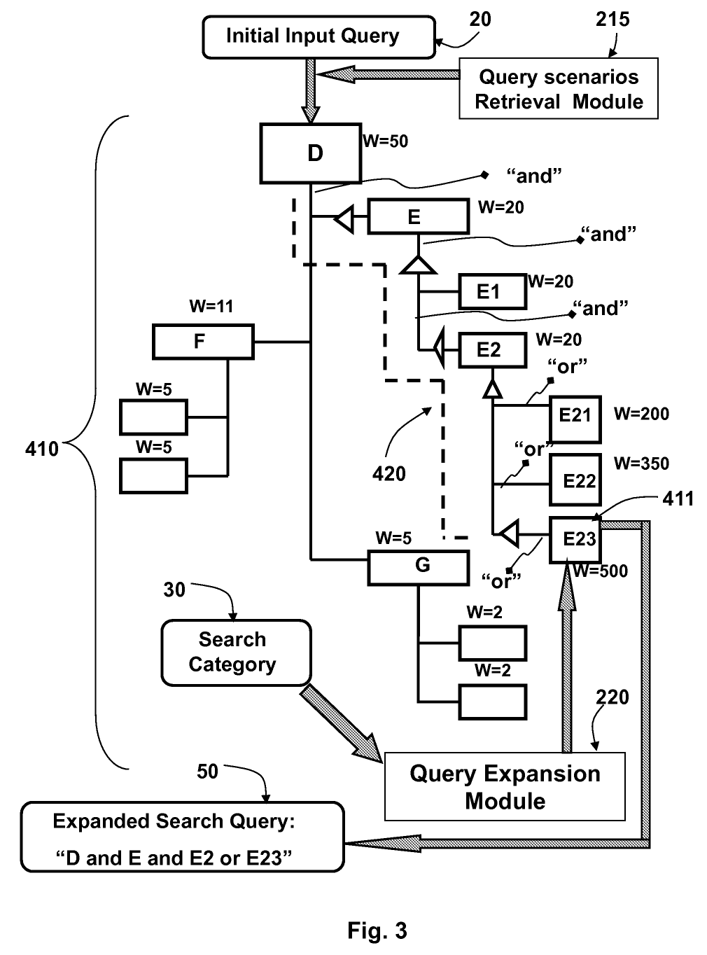

FIG. 3 schematically illustrates a query scenario tree 410 that is associated with an input query 20. The query scenario tree 410 may too be a logic tree comprising query nodes 411. Each query node 411 may be a textual phrase (one or more words) that can contribute added text to the expanded search query 50 that is being constructed. The positioning of each node 411 in relation to other nodes 411 on the same tree-branch may define the relations between the textual phrases (e.g. the relations between words e.g. “or”, “and”, etc.), where those relations may be predefined for each query tree 410. By selecting one query node 411, the user may define an entire query route 420 defining the content and structure (relations between text phrases) of the search query (meaning the textual phrases (words) and the relations between the words, respectively).

According to embodiments, as illustrated in FIG. 3, the query expansion module 220 of the search engine 200, may enable automatically retrieving of the associated query scenario tree 410 from the query scenario trees database 400, upon receiving an input query 20 from the user, and automatically selecting a query node 411 of the retrieved query scenario tree 410, where the selection of the query node 411 is carried out according to an online decision making process, which analyses the search-category in relation to the available query nodes 411 and query routes 420 of the tree 410 in order to select a query node 411 from the retrieved query scenario tree 410 that is most compatible with the search-category 30.

According to embodiments, as illustrated in FIG. 3, the decision making process for selecting the most compatible query node 411 may include online weighing of all the query nodes 411 of the retrieved query scenario tree 410 according to a predefined weighing algorithm, which takes into account the details of the search-category 30 in relation to the input query 20 and selecting the query node 411 that has the highest/best weight.

The weighing may be carried out according to any predefined technique, such as, for example, according to statistical calculations that calculate the statistical probability of each query node 411 to be suitable to the search-category 30 according to historical knowledge of users' searching behavior.

Each new search may require the user to define at least one new categorization of the search and therefore enable creating expanded search queries 50 that are more relevant to the subject of the search and can use much wider statistical behavioral knowledge to improve the query-content and detailing to enable better searches.

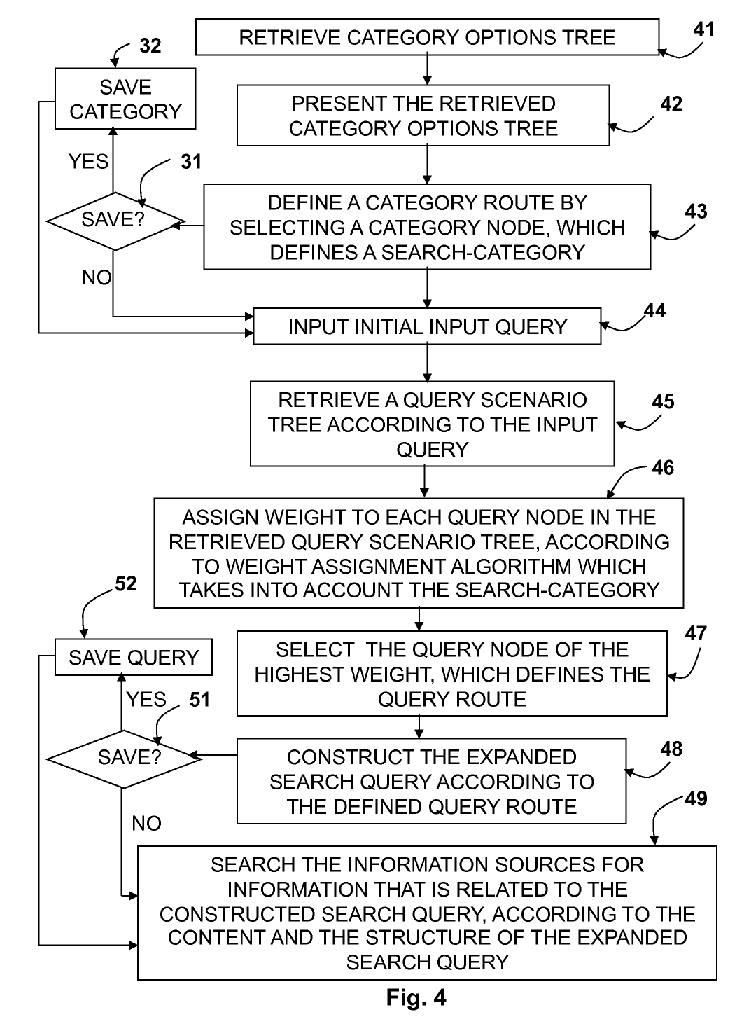

FIG. 4 is a flowchart, schematically illustrating a method of expanding a search query and searching for information related thereto, according to some embodiments of the invention. According to these embodiments, the method may comprise at least some of the following:
Retrieving a category options tree 310 (e.g. from the at least one categories database 300) 41;
Presenting the retrieved category options tree 42;
Defining a category route 43, e.g. by selecting one category node 311 that defines the route 320, which defines the search-category 30;
Inputting an initial input query 44, which may be any text phrase (comprising one or more words) inputted by the user using his/her device 10, relating to the search subject;
Retrieving a query scenario tree 410 (e.g. from the at least one query scenario trees database 400) according to the input query 45;
Assign a weight value to each query node 411 of the retrieved query scenario tree 46, according to, for example, a weight assignment algorithm, which takes into account the defined search-category 30 associated with that search;
Selecting the query node 411 that has the highest weight 47, which defines the query route 420 that is the most compatible with the search-category 30;
Constructing an expanded search query 48 according to the defined query route 420 (which defines the structure and content of the query), the initial input query 20 and according to the associated search-category 30; and
Searching the at least one information sources 49 (e.g. the advertising information source 500 and/or the general information source 500′) according to the content and structure of the constructed search query 50 and the search-category 30.

According to some embodiments, once a category route 320, defining a search-category 30, the defined search-category 30 may be save, where the search engine 200 may enable allowing the user to store all his/her defined categories 30 (see FIG. 4 steps 31-32).

Additionally or alternatively, once a query route 420, defining a search query 50, the defined search query 50 may be save, where the search engine 200 may enable allowing the user to store all his/her constructed search-queries 50 (see FIG. 4 steps 51-52).

According to embodiments, once the expanded search query 50 is constructed by the selection of the query node 411 that defines the most suitable query route 420 and query content and structure, in relation to the search-category 30, the system 100 may enable further expanding the expanded search query 50 by adding additional text that is determined according to an additional preferences algorithm, which takes into account the search-category 30.

While the invention has been described with respect to a limited number of embodiments, these should not be construed as limitations on the scope of the invention, but rather as exemplifications of some of the embodiments. Accordingly, the scope of the invention should not be limited by what has thus far been described, but by the appended claims and their legal equivalents.

What is claimed is:

1. A computer-implemented method of constructing and expanding search queries for conducting searches through at least one information source, the method comprising:
retrieving a category options tree, wherein the at least one category options tree allows a user to define a category route, which defines a search-category;
inputting an initial input query, which comprises an initial textual input for the search;
retrieving a query scenario tree, having a hierarchal structure comprising query nodes, wherein the retrieved query scenario tree is associated with the initial input query, wherein each query node comprises text that is associated with the initial input query, and wherein each query node defines a query route enabling to construct the content and structure of an expanded search query;
selecting a query node of the retrieved query scenario tree, wherein the selection of the query node is carried out according to an online decision making process, which analyses the search-category in relation to the available query nodes and query routes in order to select a query node from the retrieved query scenario tree that is most compatible with the search-category; and
constructing the expanded search query according to the query route defined by the selected query node,
wherein the selection of the query route and the determining of the search-category is carried out according to predefined rules that take into account statistical calculations of searching behavior of users, where each search-category, defined by a category route, indicates characteristics of the user.

2. The method of claim 1, further comprising searching through at least one information source for information that is related to the constructed search query, according to the content of the query and according to the structure of the query as well as according to the search-category.

3. The method of claim 1, further comprising updating at least one search categories database, wherein the category options tree for each construction of a new search query is retrieved from said at least one categories database.

4. The method of claim 3, wherein the updating includes at least one of: adding new categories and new category options trees and updating existing category option trees.

5. The method of claim 1, further comprising updating at least one query scenario trees database, by updating new query scenario trees, wherein the query scenario tree for each new inputted initial input query, is retrieved from said at least one query scenario trees database.

6. The method of claim 5, wherein the updating includes at least one of: adding new query scenario trees and updating existing query scenario trees.

7. The method of claim 1, further comprising searching through at least one advertising information source, according to the content and structure of the constructed expanded search query, which is associated with the defined search-category and the input query.

8. The method of claim 1, wherein the categories options tree is a graphical hierarchal options tree enabling the user to graphically define the search-category by selecting a graphically presented category node that defines a category route, and wherein each category route defines a specific predefined search-category.

9. The method of claim 1, wherein the decision making process, which enables selecting the query node that is most compatible with the search-category and input query, includes:
online weighing of all the query nodes of the retrieved query scenario tree according to a predefined weighing algorithm, which takes into account the details of the search-category; and
selecting the query node that has the highest weight.

10. The method of claim 1, further comprising additional expansion of the expanded search query by adding additional text that is determined according to an additional preferences algorithm, which takes into account the search-category.

11. A computerized system of constructing and expanding search queries for conducting searches in at least one information source, the system comprising:
a search engine;
at least one categories database; and
at least one query scenario trees database,
wherein the search engine comprises:
a graphical user interface (GUI) enabling the users to view and input data;
a search-categorization module, enabling to define a search-category by retrieving of at least one category options tree from the at least one categories database, wherein the category options tree is a hierarchal tree comprising category nodes, which define category routes, wherein each route defines a search-category and by allowing the user to select a category node from the retrieved options tree and thereby define a category route, which defines the search-category;
a query scenarios retrieval module, enabling to retrieve at least one query scenario tree from the at least one query scenario trees database, wherein the query scenario tree is a hierarchal tree comprising query nodes, each node defines a query route, wherein each query route defines an expanded search query, wherein the retrieval of the query scenario tree is carried out according to an initial input query, inputted by the user;
a query expansion module, enabling to expand the initial input query, by selection of a query node out of the retrieved query scenario tree, wherein the selection is carried out according to an online decision making process, which analyses the search-category in relation to the available query nodes and query routes in order to select a query node from the retrieved query scenario tree that is most compatible with the search-category; and
a search module, enabling to conduct searches through the at least one information source, according to the content and structure of the constructed search query,
wherein at least one of the search-categories, defined by at least one of the possible category routes, indicates characteristics of the user.

12. The system of claim 11, wherein the categories options tree is a graphical hierarchal options tree enabling the user to graphically define the search-category by selecting a graphically presented category node that defines the category route, which is associated with a specific search-category.

13. The system of claim 11, wherein the at least one information source includes at least one advertising information source, enabling to retrieve advertising information according to the expanded search query.

14. The system of claim 11, wherein the search engine further enables updating the at least one query scenario trees database by at least one of: adding new query scenario trees and changing existing query scenario trees.

15. The method of claim 11, wherein the search engine further enables updating the at least one search categories database by at least one of: adding new category option trees and changing existing category option trees.

16. The system of claim 11, wherein the decision making process, which enables selecting the query node that is most compatible with the search-category and input query, includes:
online weighing of all the query nodes of the retrieved query scenario tree according to a predefined weighing algorithm, which takes into account the details of the search-category; and
selecting the query node that has the highest weight.

17. A search engine for constructing and expanding search queries and conducting searches in at least one information source, wherein the search engine enables users, using computerized communication devices, to construct search queries and to search for information by communicating with the search engine through at least one data communication network, the search engine comprising:
a graphical user interface (GUI) enabling the users to view and input data;
a search-categorization module, enabling to define a search-category by retrieving of at least one category options tree, which is a hierarchal tree comprising category nodes, which define category routes, wherein each route defines a search-category and by allowing the user to select a category node from the retrieved options tree and thereby define a category route, which defines the search-category;
a query scenarios retrieval module, enabling to retrieve at least one query scenario tree, which is a hierarchal tree comprising query nodes, each node defines a query route, wherein each query route defines an expanded search query, wherein the retrieval of the query scenario tree is carried out according to an initial input query, inputted by the user;
a query expansion module, enabling to expand the initial input query, by selection of a query node out of the retrieved query scenario tree, wherein the selection is carried out according to an online decision making process, which analyses the search-category in relation to the available query nodes and query routes in order to select a query node from the retrieved query scenario tree that is most compatible with the search-category; and
a search module, enabling to conduct searches through the at least one information source, according to the content and structure of the constructed search query,
wherein at least one of the search-categories, defined by at least one of the possible category routes, indicates characteristics of the user.

18. The search engine of claim 17, further comprising a categories update module, enabling to update the at least one search categories database, wherein the updating includes at least one of: adding new category option trees and changing existing category option trees.

19. The search engine of claim 17, further comprising a queries update module, enabling to update the at least one query scenario trees database, wherein the updating includes at least one of: adding new query scenario trees; and changing existing query scenario trees.

20. The search engine of claim 17, wherein the decision making process, which enables selecting the query node that is most compatible with the search-category and input query, includes:
online weighing of all the query nodes of the retrieved query scenario tree according to a predefined weighing algorithm, which takes into account the details of the search-category; and
selecting the query node that has the highest weight.
